(19) United States
(12) Patent Application Publication
(10) Pub. No.: US 2014/0177548 A1
(43) Pub. Date: Jun. 26, 2014

(54) ELECTRONIC DEVICE, WIRELESS COMMUNICATION DEVICE, AND COMMUNICATION CONTROL METHOD

(71) Applicant: Kabushiki Kaisha Toshiba, Tokyo (JP)

(72) Inventor: Tadahiro Aihara, Hamura-shi (JP)

(73) Assignee: KABUSHIKI KAISHA TOSHIBA, Tokyo (JP)

(21) Appl. No.: 14/015,668

(22) Filed: Aug. 30, 2013

Related U.S. Application Data
(63) Continuation of application No. PCT/JP2013/058371, filed on Mar. 22, 2013.

(30) Foreign Application Priority Data
Dec. 26, 2012 (JP) 2012-282767

(51) Int. Cl. H04W 72/04

(52) U.S. Cl. CPC H04W 72/04
USPC 370/329

(57) ABSTRACT

According to one embodiment, an electronic device transmits a probe request frame to a wireless LAN access point through a first channel in a first frequency band, extracts additional information about a second frequency band higher than the first frequency band from a probe response frame received from the wireless LAN access point, changes a channel to be used by a wireless LAN device to a second channel in the second frequency band indicated by the additional information, and executes a sequence for connecting the electronic device to the wireless LAN access point by using a first service set ID indicated by the additional information and corresponding to the second channel.

### CROSS REFERENCE TO RELATED APPLICATIONS

This application is a Continuation Application of PCT Application No. PCT/JP2013/058371, filed Mar. 22, 2013 and based upon and claiming the benefit of priority from Japanese Patent Application No. 2012-282767, filed Dec. 26, 2012, the entire contents of all of which are incorporated herein by reference.

### FIELD

Embodiments described herein relate generally to a communication technique using a wireless LAN.

### BACKGROUND

In recent years, in a smartphone, personal computer, and other various electronic devices, a wireless LAN is widely utilized. In the wireless LAN, the wireless communication standard (IEEE 802.11b/g/n) using the 2.4 GHz band, and wireless communication standard (IEEE 802.11a/n) using the 5 GHz band can be utilized. Normally, in the wireless communication standard using the 5 GHz band, data communication of a speed higher than the wireless communication standard using the 2.4 GHz band can be carried out.

The 2.4 GHz band is not utilized by weather radar or the like, and hence a client of a wireless LAN can quickly be connected to an access point of the wireless LAN by carrying out active scanning.

On the other hand, the 5 GHz band is utilized by weather radar or the like, and hence a client of a wireless LAN is required to carry out passive scanning for detecting a beacon in place of active scanning in order to search for an access point of the wireless LAN of the 5 GHz band.

This is because if the client carries out active scanning, there is the possibility of a wireless signal from the client being released to a channel of the 5 GHz band which is possibly used by weather radar or the like.

The access point transmits a beacon once every 100 ms, and hence the client must keep waiting for reception of a beacon at a certain channel for at least 100 ms in order to securely receive a beacon. The number of channels which can be utilized in the 5 GHz band varies depending on the countries and districts. For example, when the number of channels is 19, scanning of all the channels of the 5 GHz band takes 1.9 seconds.

Accordingly, the client requires a comparatively long time for connection to an access point corresponding to the frequency band of the 5 GHz band.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an external appearance of an electronic device according to an embodiment.

FIG. 2 is a block diagram illustrating a system configuration of the electronic device according to the embodiment.

FIG. 3 is a view for explaining two frequency bands supported by a wireless communication device (wireless LAN access point) to which the electronic device according to the embodiment is connected.

FIG. 4 is a view illustrating a configuration of a probe response frame transmitted from the wireless communication device (wireless LAN access point) to which the electronic device according to the embodiment is connected.

FIG. 5 is a view for explaining an outline of a sequence for connecting the electronic device according to the embodiment and wireless communication device (wireless LAN access point) to each other.

FIG. 6 is a view illustrating an example of the sequence for connecting the electronic device according to the embodiment and wireless communication device (wireless LAN access point) to each other.

FIG. 7 is a flowchart illustrating a connection processing procedure to be executed by the electronic device according to the embodiment.

FIG. 8 is a flowchart showing a processing procedure to be executed by the wireless communication device (wireless LAN access point).

FIG. 9 is a block diagram illustrating a configuration of the wireless communication device (wireless LAN access point).

### DETAILED DESCRIPTION

Various embodiments will be described hereinafter with reference to the accompanying drawings.

In general, according to one embodiment, an electronic device includes a wireless LAN device configured to execute wireless data communication by using one of a first frequency band and a second frequency band higher than the first frequency band, and a control module configured to control an operation of the wireless LAN device. The control module is configured to transmit a probe request frame to a wireless LAN access point through a first channel in the first frequency band, extract additional information about the second frequency band from a probe response frame received from the wireless LAN access point, change a channel to be used by the wireless LAN device to a second channel in the second frequency band, the second channel in the second frequency band being indicated by the additional information, and execute a sequence for connecting the electronic device to the wireless LAN access point by using a first service set ID of the wireless LAN access point. The first service set ID of the wireless LAN access point corresponds to the second channel. The first service set ID is indicated by the additional information.

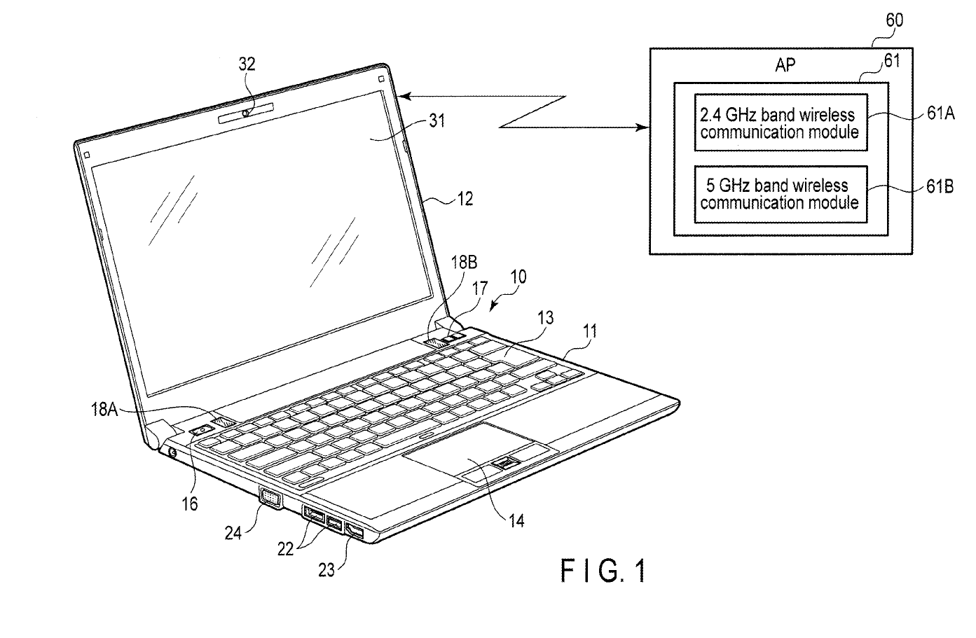

First, the configuration of an electronic device according to an embodiment will be described below with reference to FIG. 1. This electronic device can be realized as, for example, a notebook portable personal computer, tablet terminal, smartphone or other various information terminals. In the following description, it is assumed that the electronic device is realized as a notebook portable personal computer 10.

FIG. 1 is a perspective view viewed from the front side of the computer 10 in a state in which a display unit is opened. The computer 10 is configured to receive power from a battery. The computer 10 is provided with a computer main body 11, and display unit 12. In the display unit 12, a display device such as a liquid crystal display device (LCD) 31 is incorporated. Furthermore, at an upper end part of the display unit 12, a camera (web camera) 32 is arranged.

The display unit 12 is attached to the computer main body 11 in such a manner that the unit 12 can be freely rotated between an opened position at which the top surface of the computer main body 11 is exposed, and closed position at which the top surface of the computer main body 11 is covered with the display unit 12. The computer main body 11 has a thin box-like housing and, on the top surface thereof, a keyboard 13, touch pad 14, power switch 16 configured to turn on/off the power to the computer 10, some function buttons 17, and speakers 18A and 18B are arranged.

Furthermore, the computer main body 11 is provided with some USB ports 22, high-definition multimedia interface (HDMI) output terminal 23, and RGB port 24.

This computer 10 is provided with a wireless LAN device (wireless LAN module) conforming to the IEEE 802.11 standard, and can be connected to a wireless LAN access point (AP) 60. In this case, this computer 10 functions as a wireless LAN client. Each of the wireless LAN module of this computer 10 and access point (AP) 60 supports both the wireless communication standard (IEEE 802.11b/g/n) using the first frequency band (2.4 GHz band), and wireless communication standard (IEEE 802.11a/n) using the second frequency band (5 GHz band) higher than the first frequency band.

The wireless LAN module of this computer 10 is configured to execute wireless data communication by using one of the first frequency band (2.4 GHz band) and second frequency band (5 GHz band). The access point (AP) 60 can simultaneously execute wireless data communication using the 2.4 GHz band, and wireless data communication using the 5 GHz band. In other words, the access point (AP) 60 can execute wireless data communication with one or more clients by using the 5 GHz band while executing wireless data communication with other one or more clients by using the 2.4 GHz band.

The access point (AP) 60 is provided with a wireless LAN module 61. This wireless LAN module 61 is provided with two wireless communication modules which can be simultaneously operated, i.e., a 2.4 GHz band wireless communication module 61A, and 5 GHz band wireless communication module 61B. The 2.4 GHz band wireless communication module 61A supports, for example, the IEEE 802.11b, the IEEE 802.11g, and the IEEE 802.11n corresponding to the 2.4 GHz band. The 5 GHz band wireless communication module 61B supports, for example, the IEEE 802.11a, and the IEEE 802.11n corresponding to the 5 GHz band.

Furthermore, the access point (AP) 60 has a dynamic frequency selection (DFC) function configured to detect a channel in the 5 GHz band used by a system such as weather radar, and automatically select or change a channel in the 5 GHz band to be used by the access point (AP) 60 in order that interference may not occur. As described above, by using the 5 GHz band, it is possible to execute wireless data communication of a higher speed than the 2.4 GHz band. However, the client of the wireless LAN is required to carry out passive scanning for detecting a beacon frame in place of active scanning in order to search for an access point of the wireless LAN of the 5 GHz band.

As described above, the access point (AP) 60 transmits a beacon frame once every 100 ms. In order to securely receive the beacon frame, the computer 10 must keep waiting for reception of a beacon at a certain channel for at least 100 ms. When it is assumed that the number of channels which can be utilized in the 5 GHz band is, for example, 19, scanning of all the channels in the 5 GHz band requires 1.9 seconds. Actually, even when the computer 10 waits for reception of a beacon for 100 ms, the computer 10 fails to receive the beacon frame in some cases. In that case, it becomes necessary to carry out scanning again. In the case where scanning of all the channels is carried out twice, the overall scanning requires 3.8 seconds at the maximum.

In this embodiment, in each of the beacon frame transmitted by the access point (AP) 60 in the 2.4 GHz band, and probe response frame transmitted by the access point (AP) 60 in the 2.4 GHz band, additional information including a service set ID (SSID), channel information and authentication information is included, each of the service set ID (SSID), the channel information and the authentication information corresponding to the 5 GHz band. Therefore, by transmitting a probe request frame in the 2.4 GHz band, the computer 10 can acquire an SSID, channel information, and authentication information of the 5 GHz band to which the computer 10 desires to connect. Accordingly, it is possible for the computer 10 to immediately move to a channel which is used by the target wireless LAN standard of 5 GHz band without scanning a large number of channels of the 5 GHz band by means of passive scanning, and start a sequence for connecting the computer 10 to the access point (AP) 60, i.e., a sequence for connecting the computer 10 to the 5 GHz band wireless communication module 61B.

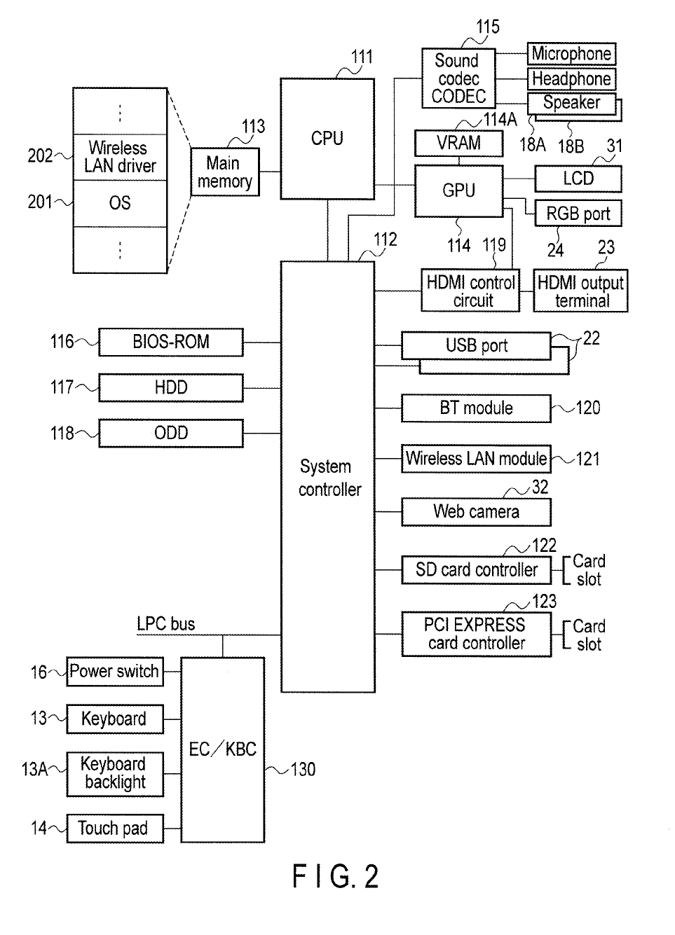

FIG. 2 shows the system configuration of the computer 10. The computer 10 is provided with a CPU 111, system controller 112, main memory 113, graphics processing unit (GPU) 114, sound codec 115, BIOS-ROM 116, hard disk drive (HDD) 117, optical disk drive (ODD) 118, BT (Bluetooth™) module 120, wireless LAN module 121, SD card controller 122, PCI EXPRESS card controller 123, embedded controller/keyboard controller (EC/KBC) IC 130, keyboard backlight 13A, and the like.

The CPU 111 is a processor configured to control an operation of each component of the computer 10. This CPU 111 executes various types of software to be loaded into the main memory 113 from the HDD 117. The software includes an operating system (OS) 201, and various types of application programs. Furthermore, the software includes a wireless LAN driver program 202. This wireless LAN driver program 202 is a program configured to control the wireless LAN module 121.

Further, the CPU 111 also executes a basic input/output system (BIOS) stored in the BIOS-ROM 116 which is a nonvolatile memory. The BIOS is a system program for hardware control.

The GPU 114 is a display controller configured to control the LCD 31 to be used as a display monitor of the computer 10. The GPU 114 creates, from display data stored in a video memory (VRAM) 114A, a display signal (LVDS signal) to be supplied to the LCD 31. Furthermore, the GPU 114 can also create an analog RGB signal and HDMI video signal from the display data. The analog RGB signal is supplied to an external display through the RGB port 24. The HDMI output terminal 23 can transmit an HDMI video signal (uncompressed digital video signal) and digital audio signal to the external display by using one cable. An HDMI control circuit 119 is an interface configured to transmit the HDMI video signal and digital audio signal to the external display through the HDMI output terminal 23.

The system controller 112 is a bridge device configured to connect the CPU 111 and each component to each other. The system controller 112 incorporates therein a serial ATA controller configured to control the hard disk drive (HDD) 117 and optical disk drive (ODD) 118. Furthermore, the system controller 112 executes communication with each device on a low PIN count (LPC) bus.

The wireless LAN module 121 is a wireless LAN device configured to execute wireless data communication conforming to the IEEE 802.11 (wireless LAN) standard. As described above, the wireless LAN module 121 supports both the wireless communication standard (IEEE 802.11b/g/n) using the 2.4 GHz band, and wireless communication standard (IEEE 802.11a/n) using the 5 GHz band.

The EC/KBC 130 is connected to the LPC bus. The EC/KBC 130 is a power management controller configured to execute power management of the computer 10, and is realized as a one-chip microcomputer incorporating therein a keyboard controller configured to control, for example, the keyboard (KB) 13, touch pad 14, and the like. The EC/KBC 130 has a function of turning on and turning off the power to the computer 10 in accordance with an operation of the power switch 16 carried out by the user. Furthermore, the EC/KBC 130 can turn on/off the keyboard backlight 13A arranged on the back surface of the keyboard 13.

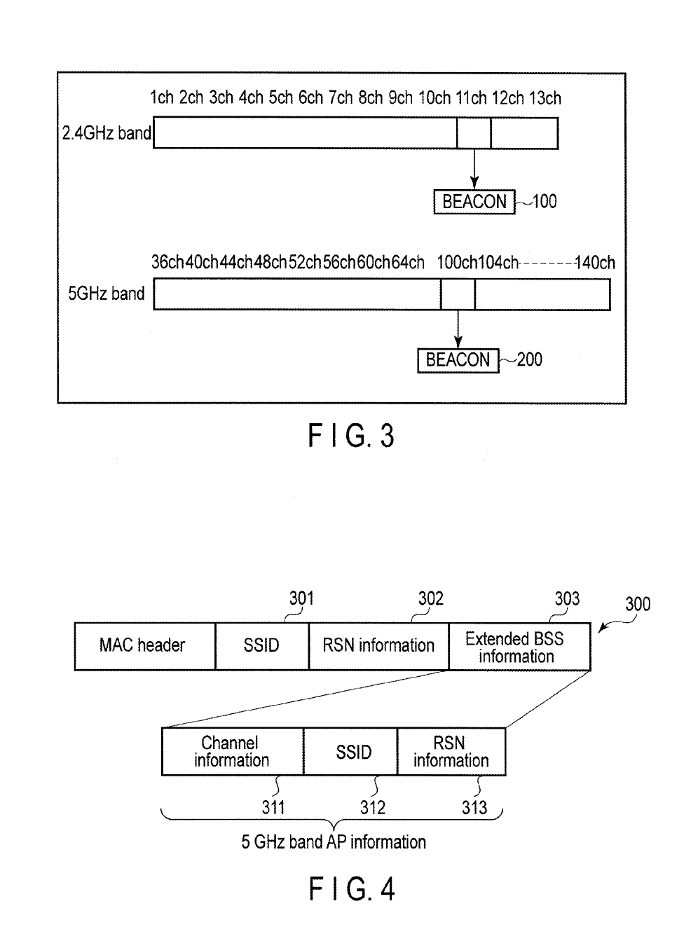

FIG. 3 shows two frequency bands used in the wireless LAN. Thirteen channels are assigned to the 2.4 GHz band. For example, nineteen channels are assigned to the 5 GHz band. Here, a case where setting is made in such a manner that the access point (AP) 60 executes wireless data communication by using, for example, the channel 11ch in the 2.4 GHz band, and executes wireless data communication by using, for example, the channel 100ch in the 5 GHz band is assumed. In the access point (AP) 60, a plurality of SSIDs which correspond to the above-mentioned plurality of wireless LAN standards may be set in advance.

The access point (AP) 60 transmits a beacon frame 100 at intervals of 100 ms in a broadcasting manner through the channel 11ch of the 2.4 GHz band. In the beacon frame 100, an SSID which is the SSID of the access point (AP) 60, and corresponds to the channel 11ch of the 2.4 GHz band is included. In other words, this SSID is an SSID corresponding to the wireless LAN standard currently using the channel 11ch of the 2.4 GHz band in the access point (AP) 60. The beacon frame 100 may further include authentication information or the like corresponding to the channel 11ch of the 2.4 GHz band. This authentication information indicates an authentication/cipher system supported by the wireless LAN standard currently using the channel 11ch of the 2.4 GHz band in the access point (AP) 60.

Furthermore, the access point (AP) 60 transmits a beacon frame 200 at intervals of 100 ms in a broadcasting manner through the channel 100ch of the 5 GHz band. In the beacon frame 200, an SSID which is the SSID of the access point (AP) 60, and corresponds to the channel 100ch of the 5 GHz band is included. In other words, this SSID is an SSID corresponding to the wireless LAN standard currently using the channel 100ch of the 5 GHz band in the access point (AP) 60. The beacon frame 200 may further include authentication information or the like corresponding to the channel 100ch of the 5 GHz band. This authentication information indicates an authentication/cipher system supported by the wireless LAN standard currently using the channel 100ch of the 5 GHz band in the access point (AP) 60.

FIG. 4 shows the configuration of a probe response frame 300 corresponding to the 2.4 GHz band used in this embodiment.

The access point (AP) 60 transmits a probe response frame 300 to a wireless LAN client, in response to reception of a probe request frame from the wireless LAN client through the currently used channel (11ch in this case) in the 2.4 GHz band.

The probe response frame 300 includes a media access control (MAC) header, service set ID (SSID) 301, robust security network (RSN) information 302, and extended BSS information 303. The SSID 301, and RSN information 302 constitute information (2.4 GHz band AP information) about the service set corresponding to the channel 11ch of the 2.4 GHz band. The SSID 301 is one of a plurality of SSIDs of the access point (AP) 60, and this SSID 301 corresponds to the channel 11ch of the 2.4 GHz band. That is, the SSID 301 is an SSID corresponding to the wireless LAN standard currently using the channel 11ch of the 2.4 GHz band in the access point (AP) 60. The RSN information 302 is authentication information corresponding to the channel 11ch of the 2.4 GHz band. That is, the RSN information 302 indicates an authentication/cipher system supported by the wireless LAN standard currently using the channel 11ch of the 2.4 GHz band in the access point (AP) 60.

The extended BSS information 303 is the above-mentioned additional information about the 5 GHz band. The extended BSS information 303 indicates information about a service set different from the service set corresponding to the channel 11ch of the 2.4 GHz band, i.e., information (5 GHz band AP information) about a service set corresponding to the channel 100ch of the 5 GHz band. This extended BSS information 303 includes channel information 311, SSID 312, and RSN information 313.

The channel information 311 indicates an effective channel in the 5 GHz band, i.e., a channel (100ch in this case) used in the 5 GHz band. The SSID 312 is the other one of the above-mentioned plurality of SSIDs of the access point (AP) 60, and this SSID 312 corresponds to the channel 100ch of the 5 GHz band. That is, the SSID 312 is an SSID corresponding to the wireless LAN standard currently using the channel 100ch of the 5 GHz band in the access point (AP). The RSN information 313 is authentication information corresponding to the channel 100ch of the 5 GHz band. That is, the RSN information 313 indicates an authentication/cipher system supported by the wireless LAN standard currently using the channel 100ch of the 5 GHz band in the access point (AP) 60.

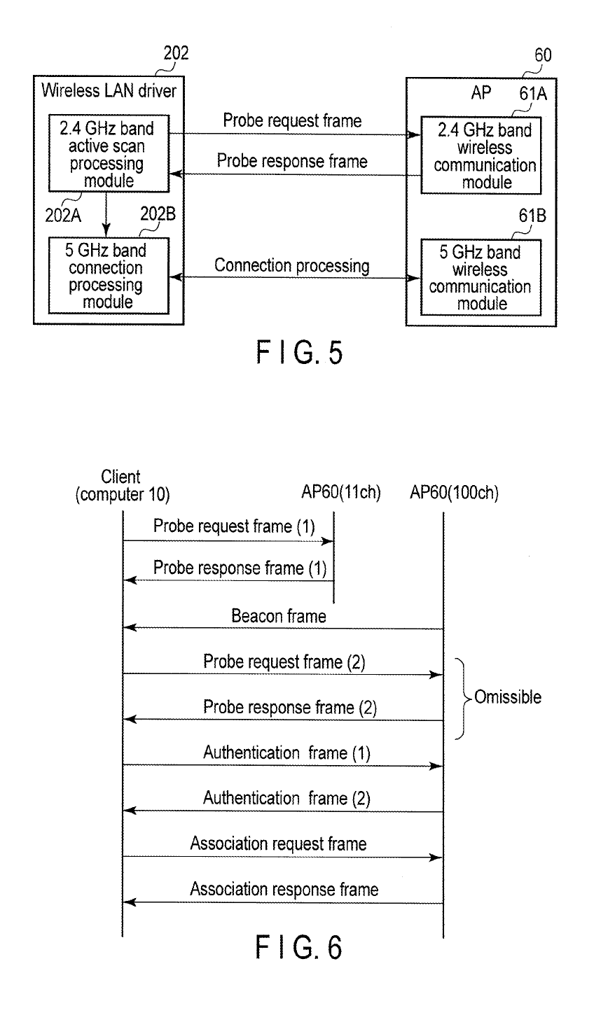

FIG. 5 shows an outline of a sequence for connecting the computer 10 and access point (AP) 60 to each other.

The wireless LAN driver program 202 of the computer 10 controls the above-mentioned wireless LAN module 121 to thereby execute processing for connecting the computer 10 to the access point (AP) 60. The wireless LAN driver program 202 is provided with a 2.4 GHz band active scan processing module 202A, and 5 GHz band connection processing module 202B as function executing modules thereof.

Here, a case where an access point to which the wireless LAN driver program 202 desires to make a connection is the 5 GHz band wireless communication module 61B, i.e., a specific access point corresponding to the 5 GHz band, and including a specific SSID is assumed. The SSID, and RSN information (authentication information) of this specific access point can be stored in the computer 10 at the time of, for example, the former connection between the computer 10 and the specific access point. The 2.4 GHz band active scan processing module 202A acquires the above-mentioned 2.4 GHz band AP information of the access point (AP) 60 by means of active scanning. That is, the 2.4 GHz band active scan processing module 202A transmits a probe request frame to the access point (AP) 60 through a certain channel (11ch in this case) of the 2.4 GHz band, and receives the above-mentioned probe response frame 300 including the extended BSS information 303 from the access point (AP) 60. Further, the 2.4 GHz band active scan processing module 202A extracts the extended BSS information 303 from the probe response frame 300, and supplies the extended BSS information 303 to the 5 GHz band connection processing module 202B.

The 5 GHz band connection processing module 202B changes the channel to be used by the wireless LAN module 121 to a channel (100ch in this case) of the 5 GHz band indicated by the channel information 311 on condition that the SSID 312 in the extended BSS information 303 coincides with the target SSID (above-mentioned specific SSID). Alternatively, the channel may be changed on condition that the combination of the SSID 312 and RSN information (authentication information) 313 in the extended BSS information 303 has coincided with the combination of the target SSID (above-mentioned specific SSID) and target RSN information (authentication information).

Further, the 5 GHz band connection processing module 202B executes the sequence for connecting the computer 10 to the access point (AP) 60, i.e., the 5 GHz band wireless communication module 61B by using the SSID 312. In this case, the 5 GHz band connection processing module 202B may wait for reception of a beacon frame at the changed channel (100ch of the 5 GHz band), and may determine whether or not an SSID included in the beacon frame is the target SSID (i.e., the SSID 312). When the SSID included in the beacon frame is the target SSID, the 5 GHz band connection processing module 202B may execute the above-mentioned sequence for connection.

It should be noted that in this embodiment, although the computer 10 has, as described above, the function of executing a connection operation in the 5 GHz band on the basis of the SSID and channel information of the 5 GHz band obtained by active scanning in the 2.4 GHz band, the computer 10 may have a function of waiting for a beacon of the 5 GHz band by an operation similar to the conventional operation. That is, the computer 10 may scan a large number of channels of the 5 GHz band one by one to detect a beacon and, when a beacon corresponding to the desired SSID is detected, the computer 10 may execute the sequence for connection. Further, the computer 10 may utilize these functions by switching them.

FIG. 6 shows an example of a sequence for connecting the computer 10 and access point (AP) 60 to each other.

The computer 10 (client) transmits a probe request frame (1) to the access point (AP) 60 through the channel 11ch. Upon receipt of the probe request frame (1), the access point (AP) 60 transmits a probe response frame (1) which has been described in connection with FIG. 4 to the client.

Upon receipt of the probe response frame (1), the client determines whether or not the SSID 312, and RSN information 313 stored in the extended BSS information 303 in this frame are the SSID, and RSN information of the access point to which the client desires to connect itself. When the SSID 312, and RSN information 313 stored in the extended BSS information 303 are the SSID, and RSN information of the access point to which the client desires to connect itself, the client acquires a channel from the channel information 311 in the frame, and moves to the channel (100ch). Movement to the channel (100ch) implies changing of the channel to be used by the wireless LAN module 121 of the client to the channel (100ch). By the movement to the channel (100ch), the frequency band used by the wireless LAN module 121 for transmission/reception of data (signal) is changed to a frequency band corresponding to the above-mentioned channel 100ch.

After the movement to the channel 100ch, the client is on standby until the access point (AP) 60 transmits a beacon frame. Further, upon receipt of the beacon frame from the access point (AP) 60, the client transmits a probe request frame (2) to the access point (AP) 60 in the same manner as the previous process. Upon receipt of the probe request frame (2), the access point (AP) 60 transmits a probe response frame (2) to the client. Upon receipt of the probe response frame (2), the client transmits an authentication frame (1) to the access point (AP) 60 when the SSID, and RSN information in the frame coincide with the SSID, and RSN information of the access point to which the client desires to connect itself. The access point (AP) 60 transmits an authentication frame (2) to the client to thereby complete authentication. Finally, the client transmits an association request frame to the access point (AP) 60, and the access point (AP) 60 transmits an association response frame to the client, whereby the connection processing is completed.

By the procedure described above, it is possible for the client to complete connection to the desired access point configured to carry out wireless data communication by using the 5 GHz band, without carrying out processing of scanning all the channels of the 5 GHz band by passive scanning.

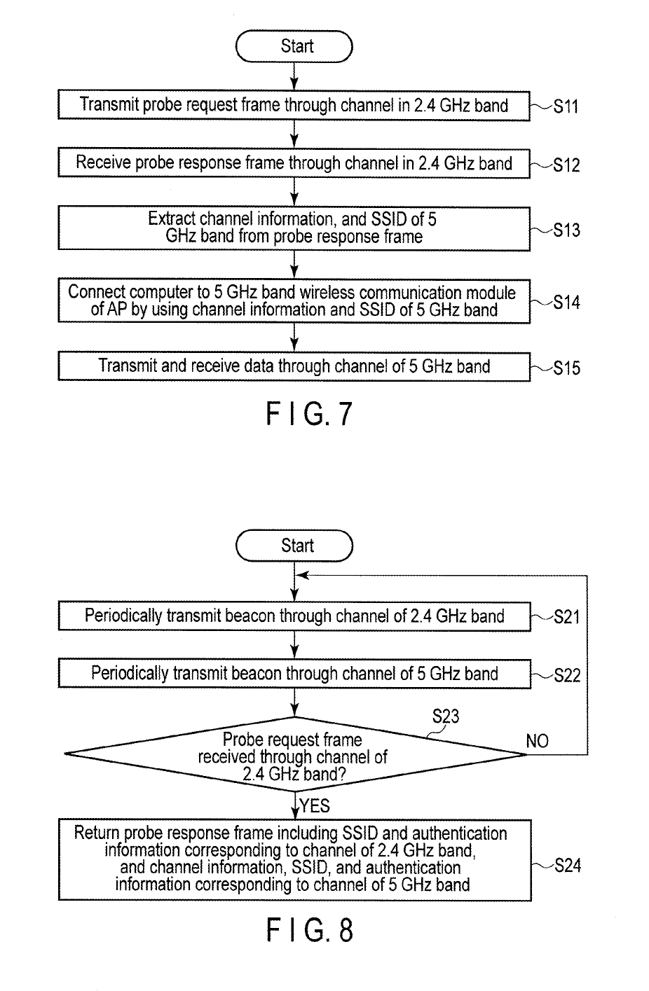

The flowchart of FIG. 7 shows the connection processing procedure to be executed by the computer 10. The computer 10 transmits a probe request frame through a channel in the 2.4 GHz band (step S11). Further, the computer 10 receives a probe response frame including the extended BSS information from the access point (AP) 60 through the above-mentioned channel in the 2.4 GHz band (step S12). The computer 10 extracts channel information, SSID, and the like of the 5 GHz band from the probe response frame (step S13). Further, the computer 10 changes the channel to be used by the wireless LAN module 121 for wireless data communication to a channel indicated by the channel information of the 5 GHz band, and executes the sequence for connecting the computer 10 to the 5 GHz band wireless communication module 61B of the access point (AP) 60 by using the SSID of the access point (AP) 60 corresponding to the 5 GHz band (step S14). After this, the computer 10 executes wireless data communication with the access point (AP) 60 through the channel of the 5 GHz band (step S15).

The flowchart of FIG. 8 shows the processing procedure to be executed by the access point (AP) 60.

The access point (AP) 60 periodically transmits the above-mentioned beacon frame 100 through a channel (e.g., 11ch) of the 2.4 GHz band, and periodically transmits the above-mentioned beacon frame 200 through a channel (e.g., 100ch) of the 5 GHz band (steps S21, and S22). It should be noted that the contents of the beacon frame 100 may be the contents similar to the probe response frame 300 described in connection with FIG. 4.

Upon receipt of a probe request frame from the client through a channel (e.g., 11ch) of the 2.4 GHz band (YES in step S23), the access point (AP) 60 creates a probe response frame having the configuration of FIG. 4, and including the SSID and RSN information (authentication information) corresponding to a channel (e.g., 11ch) of the 2.4 GHz band, and channel information, SSID, and RSN information (authentication information) corresponding to a channel (e.g., 100ch) of the 5 GHz band, and transmits the probe response frame to the client (step S24).

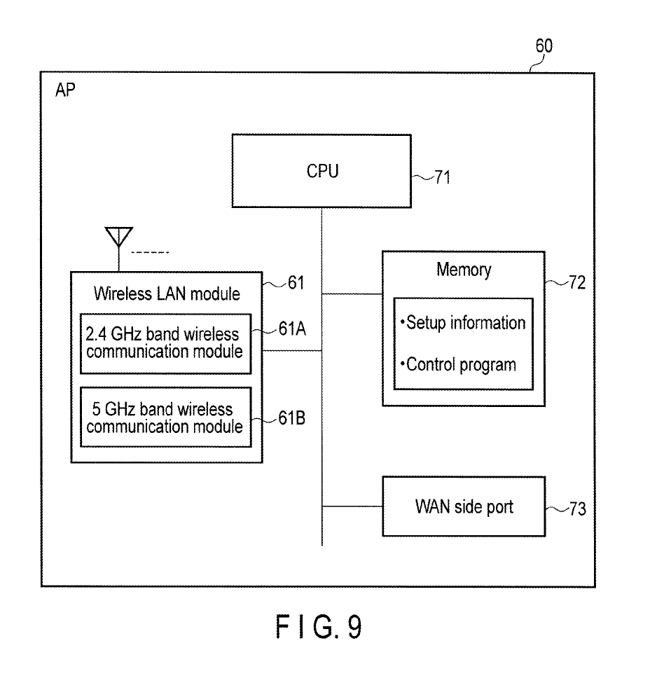

FIG. 9 shows the system configuration of the access point (AP) 60.

The access point (AP) 60 is provided with, in addition to the above-mentioned wireless LAN module 61, a CPU 71, memory 72, and WAN side port 73, and the like. In the memory 72, setup information, and control program are stored. The setup information indicates setting information of the 2.4 GHz band, and setting information of the 5 GHz band of the access point (AP) 60. The setting information of the 2.4 GHz band indicates a channel to be used in the 2.4 GHz band, and SSID and authentication information corresponding to the channel. The setting information of the 5 GHz band indicates a channel to be used in the 5 GHz band, and SSID and authentication information corresponding to the channel.

The control program controls the wireless LAN module 61 to cause the CPU 71 to execute the procedure described in connection with the flowchart of FIG. 8. Further, the control program can also execute the procedure for routing processing.

As has been described above, according to this embodiment, it is possible for the computer 10, by transmitting a probe request frame in the 2.4 GHz band, to acquire the SSID, channel information, and authentication information of the 5 GHz band to which the computer 10 desires to connect itself. Accordingly, it is possible for the computer 10 to immediately move to a channel of the 5 GHz band (channel used by the target 5 GHz wireless LAN standard), without scanning a large number of channels of the 5 GHz band by passive scanning, and start a sequence for connecting the computer 10 to the access point (AP) 60, i.e., the 5 GHz band wireless communication module 61B. Accordingly, it is possible to more effectively utilize the high-speed data communication function of the wireless LAN using the 5 GHz band.

It should be noted that the processing procedure of this embodiment can be executed by a computer program, and hence it is possible to easily realize an advantage similar to this embodiment by only installing the computer program in the computer through a computer-readable storage medium storing therein the computer program, and executing the computer program.

Further, the present invention is not limited to the embodiment described above as it is and, in the implementation stage, the constituent elements can be modified and embodied within a scope not deviating from the gist of the invention. Further, by appropriately combining a plurality of constituent elements disclosed in the above embodiment with each other, various inventions can be formed. For example, some constituent elements may be deleted from all the constituent elements shown in the embodiment. Furthermore, constituent elements ranging over different embodiments may be appropriately combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a wireless LAN device configured to execute wireless data communication by using one of a first frequency band and a second frequency band higher than the first frequency band; and
a control module configured to control an operation of the wireless LAN device,
wherein the control module is further configured to:
transmit a probe request frame to a wireless LAN access point through a first channel in the first frequency band;
extract additional information about the second frequency band from a probe response frame received from the wireless LAN access point;
change a channel to be used by the wireless LAN device to a second channel in the second frequency band, the second channel in the second frequency band being indicated by the additional information; and
execute a sequence for connecting the electronic device to the wireless LAN access point by using a first service set ID of the wireless LAN access point, wherein the first service set ID of the wireless LAN access point corresponds to the second channel and is indicated by the additional information.

2. The electronic device of claim 1, wherein
the probe response frame includes first information and the additional information, and
the first information includes a second service set ID of the wireless LAN access point, the second service set ID corresponding to the first channel.

3. The electronic device of claim 1, wherein the control module changes a channel to be used by the wireless LAN device to the second channel on condition that the first service set ID indicated by the additional information coincides with a target service set ID.

4. The electronic device of claim 1, wherein the control module waits for reception of a beacon frame at the second channel in the second frequency band, and executes the sequence for connection on condition that a service set ID included in the beacon frame coincides with the first service set ID.

5. The electronic device of claim 1, wherein
the first frequency band is a 2.4 GHz band, and
the second frequency band is a 5 GHz band.

6. The electronic device of claim 1, wherein the additional information further includes authentication information to be used in the second channel.

7. The electronic device of claim 6, wherein the control module changes a channel to be used by the wireless LAN device to the second channel on condition that a combination of the first service set ID and the authentication information which are indicated by the additional information coincides with a combination of a target service set ID and target authentication information.

8. A communication control method of an electronic device including a wireless LAN device configured to execute wireless data communication by using one of a first frequency band and a second frequency band higher than the first frequency band, comprising:
transmitting a probe request frame to a wireless LAN access point through a first channel in the first frequency band;
extracting additional information about the second frequency band from a probe response frame received from the wireless LAN access point;
changing a channel to be used by the wireless LAN device to a second channel in the second frequency band, the second channel in the second frequency band being indicated by the additional information; and
executing a sequence for connecting the electronic device to the wireless LAN access point by using a first service set ID of the wireless LAN access point, wherein the first service set ID of the wireless LAN access point corresponds to the second channel and is indicated by the additional information.

9. A wireless communication device configured to execute wireless data communication using a first frequency band and wireless data communication using a second frequency band higher than the first frequency band,
wherein the device is further configured to:
transmit a first beacon frame through a first channel in the first frequency band;
transmit a second beacon frame through a second channel in the second frequency band; and
transmit to a wireless LAN client a probe response frame in response to reception of a probe request frame from the wireless LAN client through the first channel, wherein the probe response frame includes additional information indicating the second channel and a first service set ID of the wireless communication device, and wherein the first service set ID corresponds to the second channel to the wireless LAN client.

10. The wireless communication device of claim 9, wherein
the probe response frame includes first information and the additional information, and
the first information includes a second service set ID of the wireless communication device, the second service set ID corresponding to the first channel.
